(19) United States
(12) Patent Application Publication
(10) Pub. No.: US 2011/0034164 A1
(43) Pub. Date: Feb. 10, 2011

(54) METHOD AND COMPUTER SOFTWARE PRODUCT FOR ANALYZING CELLULAR MOBILE-TELEPHONE NETWORKS

(75) Inventor: Andreas Spachtholz, Zangberg (DE)

Correspondence Address: DITTHAVONG MORI & STEINER, P.C., 918 Prince Street, Alexandria, VA, 22314, US

(73) Assignee: Rohde & Schwarz GmbH & Co. KG, Muenchen (DE)

(21) Appl. No.: 12/373,238

(22) PCT Filed: Jun. 21, 2007
(86) PCT No.: PCT/EP07/05484

§ 371 Date: Aug. 14, 2009

(30) Foreign Application Priority Data
Jul. 11, 2006 (DE) 10 2006 032 089.1

(51) Int. Cl. H04W 24/00

(52) U.S. Cl. 455/423

(57) ABSTRACT

A method for analyzing cellular mobile-telephone networks includes determining a quality criterion for transmitters receivable at one location, specifying the best quality transmitter as a target transmitter, forming transmitter pairs from the target and one receivable transmitter, and testing for the pairs, whether the receivable transmitter of the pair is a possible active neighbor or potential interferer. The receivable transmitters provide a quality ranking, the testing of the pairs corresponds to the rank order and, in the case of a potential interferer marking, a distinction is made between a first type and a second type, and a first type marking is implemented if the receivable transmitter is not contained in the read in transmitter list made available by the provider and is identified as a potential interferer, and a second type marking is implemented if the receivable transmitter is contained in the list and is identified as a potential interferer.

### CROSS-REFERENCE TO RELATED APPLICATION

The present application claims priority to German Patent Application No. 10 2006 032 089.1, filed on Jul. 11, 2006, and is a national phase filing of PCT Application No. PCT/EP2007/005484, filed on Jun. 21, 2007, the entire contents of which are herein incorporated by reference.

### BACKGROUND OF THE INVENTION

1. Field of the Invention

The invention relates to a method and a corresponding computer program for analyzing cellular mobile-telephone networks.

2. Discussion of the Background

Mobile-telephone networks constructed in a cellular manner are planned with the use of simulation programs. The results of the simulation lead to the positioning and power adjustment of the individual base stations, which are supposed to achieve a region-wide provision of the respective network. In this context, local conditions cannot always be reproduced accurately in the simulation. In practice, this means that, for example, in the case of third-generation mobile telephones (UMTS), more transmitters can be received by a mobile-telephone device at a given position than the transmitters forming a so-called “active set”. This can lead to interference of the actually-provided transmission, which is shared between the several transmitters of an “active set”.

In order to determine the real network conditions, it is therefore necessary to measure the actual network situation with regard to possible reception locations using measurement technology, so that the real network can be optimized on the basis of actual conditions.

### SUMMARY OF THE INVENTION

The invention therefore advantageously provides a method and a corresponding computer program product, which can analyze the reception situation with reference to the different neighboring transmitters in a mobile-telephone network.

According to the invention, the cellular mobile-telephone network is analyzed by determining respectively at one location at least one quality criterion for several transmitters receivable at that point. The transmitter, which provides the signal with the best quality at this location is then determined from these quality criteria. The transmitter with the best quality is then defined as the target transmitter, for which the subsequent analysis is implemented. A target transmitter of this kind is also referred to as the “best server”. Transmitter pairs are formed respectively from a target transmitter specified for a given location and the other receivable transmitters. At least one part of the transmitter pairs formed in this manner is tested to determine whether the receivable transmitter, which forms the transmitter pair together with the target transmitter, is a possible active neighbor or a potential interferer. A transmitter, which could contribute to the transmission of data to a mobile-telephone device at the given location, but which does not do so within the current network configuration, is defined as a possible active neighbor. Transmitters, which cannot contribute to the transmission of data to the mobile-telephone network at the given location, but which are receivable at the location of the mobile-telephone device with a transmission power, which could represent an interference of reception, are defined as potential interferers.

According to an embodiment of the method, a signal from a transmitter is received at a given location. This signal is decoded and the neighbor list contained in the decoded signal is determined. A transmitter list, which is specified by the respective network operator is additionally read in. The transferred neighbor list is compared with the transmitter list made available by the provider, and an alarm is output in the presence of any differences. In this manner, it is possible to determine whether the transmitters contained in the transmitter lists supplied by the provider are actually communicated in the real network component in identical form to a mobile telephone subscriber. Differences may indicate an error in network planning.

In particular, it is advantageous to read in a transmitter list specified by the provider respectively for one target transmitter of a transmitter pair formed. This transmitter list specified by the provider establishes the active neighbors for each target transmitter. As already explained above, active neighbors are those transmitters, which form a so-called “active set” together with the target transmitter. The existence of a receivable transmitter of the transmitter pair in the transmitter list is tested.

Furthermore, in the absence of the receivable transmitter of transmitter pair in the transmitter list, it is advantageous to compare the determined quality criterion with a first comparison criterion. If the quality criterion of the receivable transmitter of the transmitter pair fulfils the comparison criterion, this receivable transmitter is defined as a possible active neighbor, unless the maximum number of active neighbors for this target transmitter has already been reached. This means that a transmitter, of which the signal is receivable with a sufficient quality at the given location, but which is not provided for data transmission with a mobile-telephone device disposed at the given location, is marked as a possible active neighbor. Locating transmitters of this kind allows the network operator to adapt its network so that the mobile-telephone device operated respectively within the network can be informed in future of a possible active neighbor of this kind as a transmitter in the so-called “active set”.

By contrast, if the maximum number of active neighbors of the target transmitter has already been reached, because other transmission stations are transmitting signals of a better quality, and the quality of the received signal from the receivable transmitter is sufficiently good to fulfil the first comparison criterion, the quality criterion of this receivable transmitter is compared with a second comparison criterion, and it is identified as a potential interferer, if this second comparison criterion is also fulfilled. In this context, the second comparison criterion is a minimum quality, which is less than the quality according to the first comparison criterion. An object of the second criterion is to prevent a receivable transmitter from being classified as a potential interferer, although its signal quality is so poor, that an interference of the data transmission is not to be expected.

According to a further preferred embodiment, a receivable transmitter of a transmitter pair is also marked as a potential interferer, if it is listed as a neighbor transmitter in the transmitter list supplied by the provider, but the maximum possible number of active neighbors has already been reached. A transmitter of this kind cannot be included in the “active set”, because a data transmission between the mobile-telephone device and several mobile-telephone transmitters is possible only for the maximum number of the “active set”. A further transmitter, of which the signal quality is sufficient in order theoretically to be a transmitter of the “active set”, therefore leads to interfering influences.

Furthermore, it is advantageous to distinguish between different types of potential interferers. In particular, it is advantageous to distinguish between potential interferers of type 1 and potential interferers of type 2, the distinction being made dependent upon a test to determine whether the potential interferer is listed in the transmitter list from the provider or not.

The results for every transmitter pair are preferably stored in a table. Furthermore, it is particularly advantageous to establish an absolute threshold value and/or a relative threshold value for the inclusion of a receivable transmitter. This reduces the quantity of data to be processed, because only those transmitters are included, which can be received by the test device with a minimum quality. Accordingly, the first threshold value is preferably a first absolute threshold value, which specifies in a simple manner a lower limit for the reception quality. The second, relative threshold value is preferably specified relative to the reception quality of the target transmitter, so that a relative interval can be established for the reception quality of the target transmitter. In this context, it is particularly advantageous if both criteria are provided as compulsory criteria.

The test regarding whether the respectively receivable transmitter of a transmitter pair is a possible active neighbor or a potential interferer, is implemented by repeating the procedure of the method for all transmitter pairs. Furthermore, this test is repeated at a plurality of locations and the results for these individual locations are listed in table. Accordingly, each allocation is implemented with reference to the transmitter pairs formed. The results in the table can be visualised particularly readily in a map display. In order to identify the transmitter, a signal received from this transmitter is preferably decoded and evaluated. The transmitter identification code contained therein identifies every transmitter in an unambiguous manner. If a signal of this kind from the receivable transmitter cannot be decoded and the transmitter identification cannot be received directly, the receivable transmitter is identified taking into consideration its geographical position.

In order to avoid unnecessarily-large volumes of data to be processed, the testing of the transmitter pairs can be triggered subject to time control and/or spatial control. For example, a measurement series can be implemented along a road with a test vehicle, a measurement being triggered, for example, every hundred meters. Information regarding neighbor relationships of the individual transmitters is therefore obtained in a 100 meter grid. This can be particularly advantageous if rapid geographical changes are not anticipated, as occurs, for example, in thinly-populated areas. By contrast, in centers of population, it may be necessary to implement a plurality of measurements in order to improve the measurement quality.

### BRIEF DESCRIPTION OF THE DRAWINGS

The methods according to the invention are presented in the drawings with reference to a preferred embodiment and explained in greater detail in the description below. The drawings are as follows:

FIG. 1 shows an extremely simplified presentation of a mobile-telephone network and a test run;

FIG. 2 shows a schematic presentation of a procedure of the method for the formation of transmitter pairs;

FIG. 3 shows a schematic presentation for the analysis of the given transmitter pairs;

FIG. 4 shows a presentation of the results for a plurality of transmitter pairs in tabular form; and

FIG. 5 shows an exemplary presentation for the output of differences between the transmitter list and a transferred neighbor list.

### DETAILED DESCRIPTION OF EXEMPLARY EMBODIMENTS OF THE INVENTION

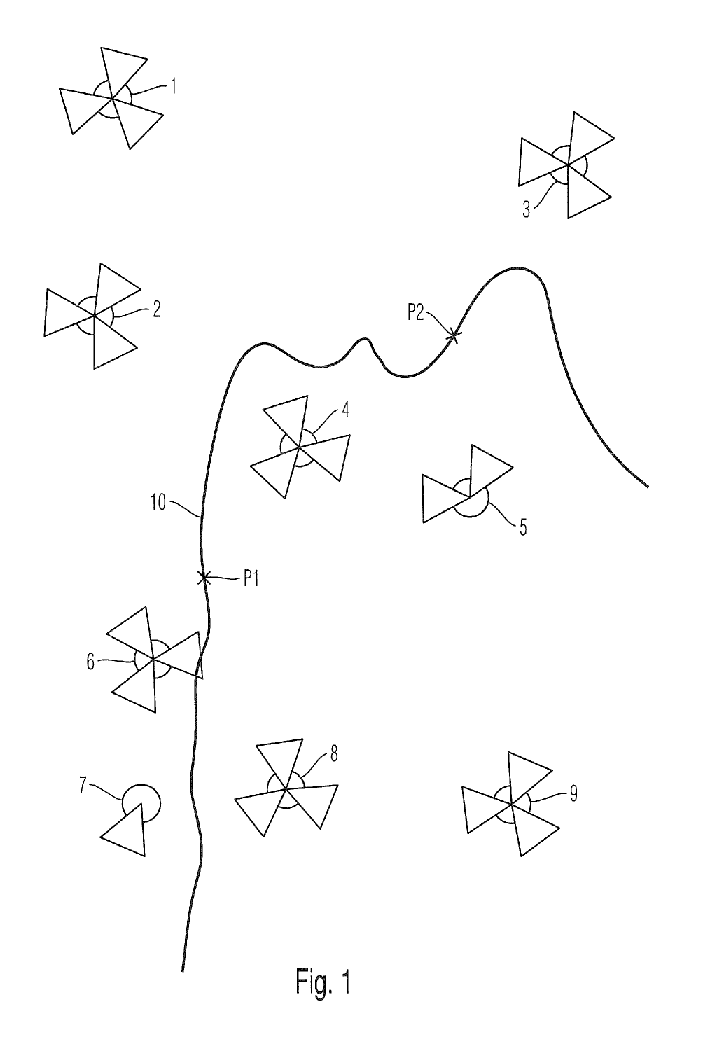

By way of example, FIG. 1 shows a possible arrangement of a plurality of mobile-telephone base stations 1 to 9. Dependent upon network planning, the mobile-telephone stations 1 to 9 can be designed either to transmit all around, or they may provide a directional characteristic, as illustrated schematically for base stations 5 and 7.

The base stations are either base stations of a GSM network or of a UMTS network, that is to say, third-generation mobile telephones.

In the context of third-generation mobile telephony, data transmission is realized with a plurality of transmitters, which communicate simultaneously with a mobile-telephone device. In the following deliberations, it is assumed that the maximum number of transmitters in an “active set” of this kind is three. Accordingly, a change in the allocation between the individual base stations contributing to the data transmission must be guaranteed during the progressive movement of the mobile-telephone device. Reference number 10 indicates an example of a possible test run, for example, along a road through an area, in which the plurality of illustrated base stations 1 to 9 are transmitting. If the mobile-telephone device is disposed at point P1, the “active set” may consist, for example, of base stations (Node B) 4, 6 and 8. In real operation, the network operator specifies which base stations can form the active set. The mobile-telephone device, which is registered with the network, is notified of these base stations via an air interface.

A so-called “active set” is formed from one target transmitter, the so-called “best server”, and selected neighbor transmitters. That transmitter 1 to 9, of which the signal can be received at point P1 with the best quality, is defined as the best server (BS). The “active set” is then formed from this best server and two other, so-called active neighbors. In real network operation, the mobile-telephone device is notified regarding which neighbors can form the active set dependent upon the location of the mobile-telephone device in the cell. For this purpose, a transmitter list, which is specified by the provider, exists for every base station. This transmitter list, which is provided specifically for every base station, indicates those neighbor transmitters, which can form an active set together with the best server. For example, by way of explanation of the point P1, let the base station at reference number 6 be the best server. For the base station with the reference number 6, the provider specifies a list TopN_{Prov.} of possible active neighbors, which contains the base stations 4 and 8. Accordingly, base stations 4, 6 and 8 together form an active set.

In constructing a network, the arrangement of the base stations and their respective transmission power and directional characteristics are initially defined on the basis of simulations. However, the real operational conditions may deviate from the assumed, marginal conditions of the simulation. This could mean, for example, that in addition to base stations 4, 6 and 8, a significant signal power with good-quality can actually be received at point P1 from a signal transmitted from base station 2. Accordingly, the signal received at point P1 from base station 2 may, under some circumstances, be of an even better quality than, for example, the signal received from base station 4. In consequence, in real mobile-telephone operation, the signal from base station 2, which, according to the network specifications, should not be in communication with a mobile-telephone device at point P1, would interfere with the data transmission of the mobile-telephone device at point P1 with its active set consisting of the base stations 4, 6 and 8.

The present method determines neighbor relationships of this kind between the plurality of available mobile-telephone base stations 1 to 9. For this purpose, a measuring device is moved, for example, along the test run 10, and the individual neighbor relationships are analyzed in a manner to be explained in greater detail below. In each case, the neighbor relationships are determined for a given target transmitter BS, wherein the respective neighbors may be base stations for mobile telephones of the third-generation (UMTS) and also base stations for mobile telephones of the second generation (GSM). The analysis is required both for mobile telephones of the third generation and also for mobile telephones of the second generation, because the mobile-telephone device switches from the third generation (3G) to the second generation (2G), if a supply from transmitters of the third generation is not provided within the corresponding regional area. The “best server” is determined for every point P1, P2, for which an analysis is implemented, by measuring a quality criterion for all transmitters receivable at this point P1, P2.

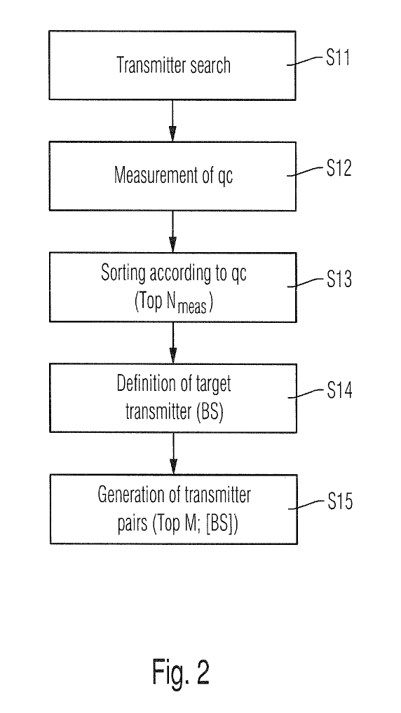

The following description for the implementation of the method is provided with reference to FIG. 1, wherein it is assumed, that a test vehicle is moving along the test run 10 and that a measuring device is disposed on board the test vehicle. As presented in the form of a procedural flow chart in FIG. 2, in procedural stage S11, this measuring device samples the frequencies of a mobile-telephone network. Accordingly, the individual transmitters, which are receivable, for example, at point P1, are determined. A quality criterion qc is measured for the transmitters receivable at point P1. The quality criterion qc is defined in the respective standard, and, in the case of UMTS, relates to chip energy/interference (EC/IO).

The quality criterion qc measured in procedural stage S12 is used for the preparation of a ranking list of all receivable transmitters. The ranking list is prepared in procedural stage S13, wherein all receivable transmitters are sorted according to the determined quality criterion qc. For the further description, let it be assumed that the best received signal is associated with the transmitter disposed at position 1 in the ranking list. Accordingly, a list with N entries is obtained for a total of N receivable transmitters. This list is referred to below as TopNₘₑₐₛ.

The transmitter disposed in ranking position 1 of this TopNₘₑₐₛ list is defined as the target transmitter (“best server”).

On the basis of the definition of the target transmitter BS, in procedural stage S14, transmitter pairs consisting of the target transmitter BS and in each case a receivable transmitter TopM from the TopNₘₑₐₛ list are generated. This results in a plurality of transmitter pairs (TopM; BS). In this context, M is the ranking position in the sorted, measured list TopNₘₑₐₛ.

For example, if the signal from transmitter 6 is qualitatively of the highest value at point P1 in FIG. 1, transmitter 6 will appear in the TopNₘₑₐₛ list in position 1, that is to say, as transmitter Top1. If the signal from transmitter 8 is qualitatively second-best at point P1, it will appear at position 2 in the list. The transmitter with the third-best received signal, for example, transmitter 4, will be listed at position 3 of the TopNₘₑₐₛ list. Transmitter 2, for example, could transmit the fourth-best signal received at point P1 and would consequently form the fourth entry in the TopNₘₑₐₛ list. Accordingly, with the total of four transmitters Top1-Top3 receivable at point P1, a TopNₘₑₐₛ list with four entries would be obtained, from which, according to the definition of the first entry, three transmitter pairs ((Top1; BS), (Top2; BS), (Top3; BS)) can be formed.

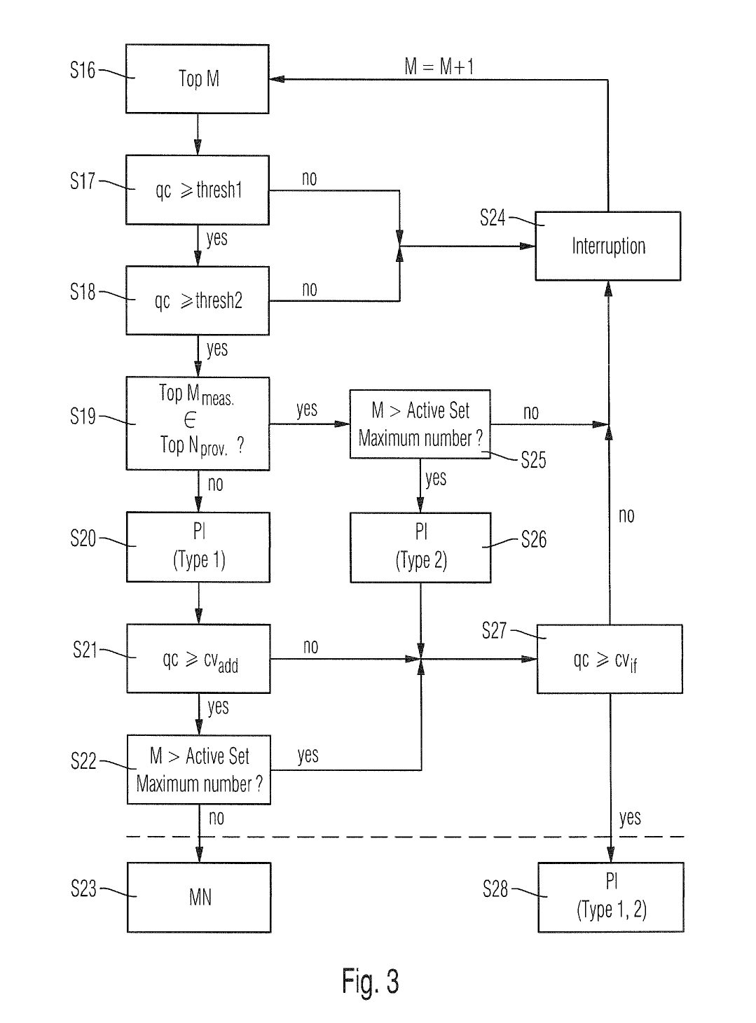

For every transmitter pair (TopM; BS), which consists of the target transmitter BS and one receivable transmitter TopM from the TopNₘₑₐₛ list, the quality of the receivable transmitter TopM is tested and, accordingly, a classification as a potential interferer (PI) or as possible active neighbor (MN) is implemented. The method, which is implemented on the basis of a formed transmitter pair (TopM; BS), is illustrated in simplified form in FIG. 3.

In this context, the index M forms a running index, as obtained from the rank order in the TopNₘₑₐₛ list. For example, a test of the individual receivable transmitters TopM of every transmitter pair (TopM; BS) is implemented systematically according to the rank order of the TopNₘₑₐₛ list. Initially, in procedural stage S16, the receivable transmitter TopM is selected. After the formation of the transmitter pairs (TopM; BS), this would be, for example, the transmitter disposed at position 2 of the TopNₘₑₐₛ list. In procedural stage S17, a test is carried out for this receivable transmitter TopM to determine whether the quality criterion qc is greater than a first threshold value thresh1. The first threshold value thresh1 is preferably an absolute threshold value. Beneath this absolute, first threshold value thresh1, the received signal at point P1 is so weak, that a further analysis of this receivable transmitter TopM is not relevant. The threshold value thresh1 is preferably adjustable in the measuring device. If the receivable signal is of a better quality than is specified by the first threshold value thresh1, the quality criterion qc is tested with reference to a second threshold value thresh2.

The second threshold value thresh2 is preferably specified relative to the quality criterion qc of the target transmitter BS of the transmitter pair (TopM; BS). If it is determined in procedural stage S17 or S18 that the quality criterion qc falls below either the first threshold value thresh1 or the second threshold value thresh2, the further analysis is interrupted, and the procedure jumps back, via the interrupt stage S24, to the start of the method to be implemented. Accordingly, the index M of the receivable transmitter TopM is increased by 1, so that, instead of the first receivable transmitter Top2 of the first transmitter pair (TopM; BS), the second receivable transmitter (Top3) is now investigated.

By contrast, if it is determined in procedural stage S18 that the quality criterion also exceeds the second threshold value thresh2, a test is implemented to determine whether this receivable transmitter TopM is listed in the transmitter list TopN_{Prov.} supplied by the provider.

As has already been mentioned, the provider specifies for each target transmitter BS, those neighbor transmitters which can contribute as active neighbors to a connection and to the transfer of data.

In the case of the exemplary embodiment explained with reference to FIG. 1, the transmitter 6 is the target transmitter BS at point P1. It forms the “active set” together with the transmitters 4 and 8. The transmitters 4 and 8 are therefore listed in the transmitter list TopN_{Prov.} for the target transmitter 6. If procedural stage S19 is now implemented for transmitter 2, which supplies the fourth-best signal, it is determined in procedural stage S19 that the signal of transmitter 2 (Top4) is not contained in transmitter list TopN_{Prov.} from the provider. Accordingly, transmitter 2 from FIG. 1 (Top4) is identified in procedural stage S20 as a potential interferer (PI) of the first type. In the analysis according to the invention, the active set is therefore filled up according to the rank order of the measured TopNₘₑₐₛ.

If a transmitter TopM has been identified in procedural stage S20 as a potential interferer PI, further tests are carried out to determine whether this given transmitter TopM could possibly also come into consideration as an active neighbor MN, that is to say, as a transmitter of the active set. For this purpose, the quality criterion qc is compared with a first comparison criterion cv_{add}. The comparison criterion cv_{add} specifies a threshold value for the quality. Above this threshold value for the quality qc of the potential interferer PI, the received signal from this potential interferer PI is of such a high quality, that it could contribute to a data transmission. The level of the comparison criterion cv_{add} is preferably specified relative to the signal quality qc of the target transmitter BS.

If the comparison in procedural stage S21 shows that the potential interferer PI also comes into consideration as a possible transmitter of the active set because of its good signal quality, further tests are implemented to determine whether the active set of the target transmitter BS is already full. In our example, the active set consisted of the transmitter 6 as the target transmitter with the other transmitters 8 and 4. This exhausted the maximum number of transmitters in the active set, which we had taken to be three. Accordingly, if the quality criterion qc of the fourth transmitter of the TopNₘₑₐₛ is greater than the first comparison criterion cv_{add}, it will still be established, as a result of the test in procedural stage S22, that an adoption into the active set is not possible.

In the event that an adoption into the active set is not possible because the active set has already been filled, the procedure branches to stage S27. In procedural stage S27, the quality criterion qc of the receivable transmitter TopM is compared with a second comparison criterion cv_{if}. The second comparison criterion cv_{if} specifies a second threshold value for the quality criterion qc, which is lower than first threshold value cv_{add}. The second comparison criterion cv_{if} specifies a threshold value, below which a consideration of this transmitter TopM is not required, because the quality of the received signal from this transmitter TopM at point P1 is so poor, that interference of the actual data transfer is not to be expected. The level of this threshold value can also be adjusted in the measuring device. In the exemplary embodiment presented, it has been assumed that the quality criterion qc is disposed above the first comparison criterion cv_{add}, but the active set for this target transmitter BS is already full. In this case, the comparison of the quality criterion qc with the second comparison criterion cv_{if} shows that this comparison criterion cv_{if} is also fulfilled, that is to say, the quality criterion qc is greater than or equal to the second comparison criterion cv_{if}. In procedural stage S28, this receivable transmitter is shown by the measuring device as a potential interferer PI.

By contrast, if it is determined in procedural stage S21 that the receivable transmitter TopM initially defined as a potential interferer PI provides a quality criterion qc, which is greater than or equal to the first comparison criterion cv_{add} and, moreover, that the active set of the target transmitter BS is not yet full, the receivable transmitter TopM is marked as a possible active neighbor MN. A possible active neighbor (missing neighbor, MN) is therefore obtained, if the quality of the received signal from the receivable transmitter TopM permits an inclusion in the active set, and this active set is not yet full. This situation occurs, for example, if only the further transmitter 8 is provided by the network operator in the TopN_{Provider} list for target transmitter 6 of FIG. 1 for the formation of the active set at point P1. The active set can consist of a maximum of three transmitters (BS;Top2;Top3), which communicate simultaneously with the mobile-telephone device.

If the TopN_{Prov.} list contains only the target transmitter 6 and the one further transmitter 8, it will be determined, even during the investigation of the transmitter with the third-best quality criterion qc, that this receivable transmitter is not contained in the TopN_{Prov.} list. By contrast, if the TopN_{Prov.} list consists of the target transmitter 6, the further transmitter 8 and the further transmitter 4, it will be determined, in the testing of the transmitter Top3 in procedural stage S16 or subsequently in procedural stage S19, that the transmitter Top3, which corresponds to the further transmitter 4 in our exemplary embodiment above, is contained in the transmitter list TopN_{Prov.}

In implementing the analysis of the mobile-telephone network, the active set is filled up in each case on the basis of the sorting of receivable transmitters. That is to say, for the target transmitter 35(6) of FIG. 1, the active set is filled by the second-best and the third-best receivable transmitter. If it is determined in procedural stage S19 for the transmitter 4, which is the Top3 transmitter according to the sorted rank order TopNₘₑₐₛ, that this transmitter is contained in the TopN_{Prov.} list for the target transmitter 6, it will also be determined in procedural stage S25 that the maximum number of transmitters of the active set has not yet been exceeded and, the procedure will jump back via procedural stage S24 to the beginning of the flow chart for the method.

Let it now be assumed that the quality criterion qc of transmitter 2 is better than the quality criterion of transmitter 4. The TopN_{Prov.} list still consists of the target transmitter 6 and the further transmitters 8 and 4. But because of the now-changed order of the sorted ranking list TopNₘₑₐₛ, in which transmitters 6, 8, 2 and 4 are defined as Top1 to Top4, it is now initially determined, in the testing of the transmitter 4 (Top4) in procedural stage S19, that this transmitter 4 (Top4) is contained in the TopN_{Prov.} list. However, further testing in procedural stage S25 shows that the active set is already full. The transmitters Top1 to Top3 are automatically included in the active set during the testing procedure. An adoption of the transmitter Top4, which corresponds to the transmitter 4 in FIG. 1, into the active set is therefore not possible, and the fulfilment of the interrupt criterion in procedural stage S25 leads to an identification of the Top4 transmitter 4 as a potential interferer PI in procedural stage S26.

Accordingly, in procedural stage S20 and in procedural stage S26, there are two markings of a receivable transmitter TopM as a potential interferer PI. In this context, potential interferers PI are defined as type1 potential interferers PI, which are not listed in the TopN_{Prov.} list. By contrast, transmitters TopM, which are in fact included in the TopN_{Prov.} list from the provider, but which cannot be included in the active set because this is already filled with qualitatively higher-value transmitters TopM, are defined as type2 potential interferers PI.

If a receivable transmitter TopM is identified in procedural stage S26 as a type2 potential interferer PI, starting from procedural stage S26, the procedure moves to stage S27, in which the quality criterion qc is tested with regard to the second comparison criterion cv_{if}. Accordingly, for the type2 potential interferer PI also, a test is again implemented to determine whether its quality criterion qc is sufficiently high in order to be actually relevant as an interferer M. If the second comparison criterion cv_{if} is fulfilled, this receivable transmitter TopM of the transmitter pair (TopM; BS) is shown as a potential interferer PI in procedural stage S28. The distinction according to type1 and type2 is preferably marked in the output of the potential interferer PI. Accordingly, it is not only known that an interferer PI is present; it is also known whether this potential interferer PI was specified by the provider as actually belonging to the active set.

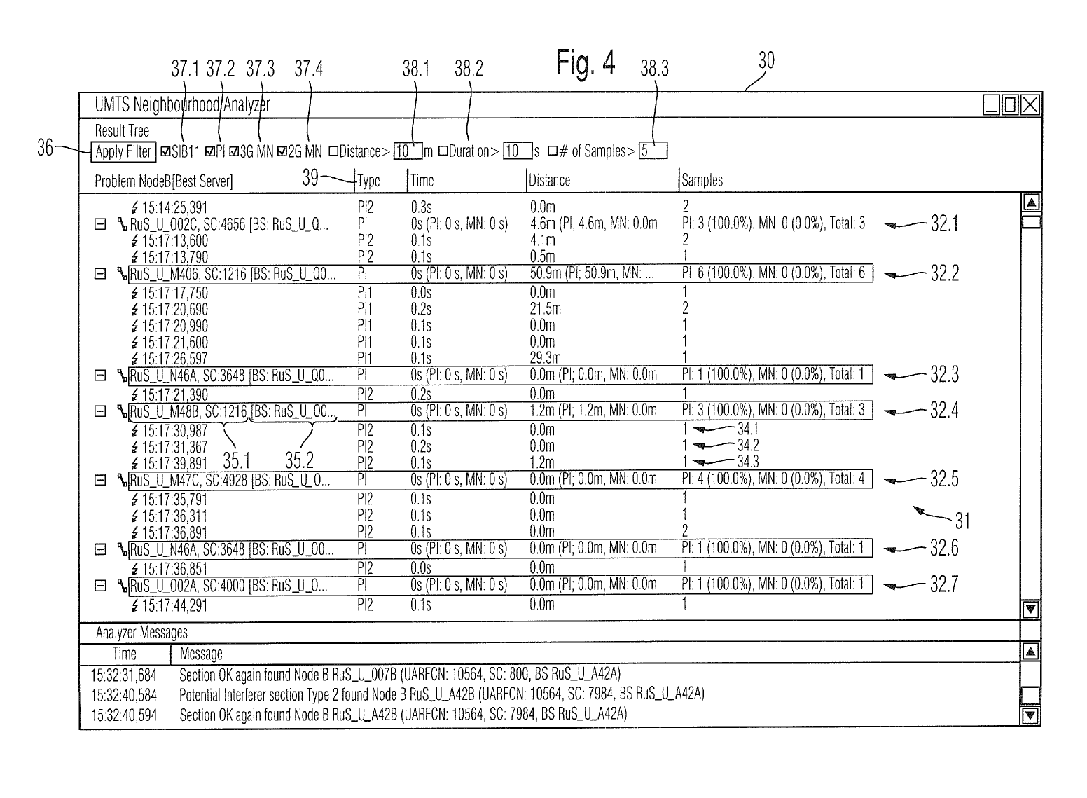

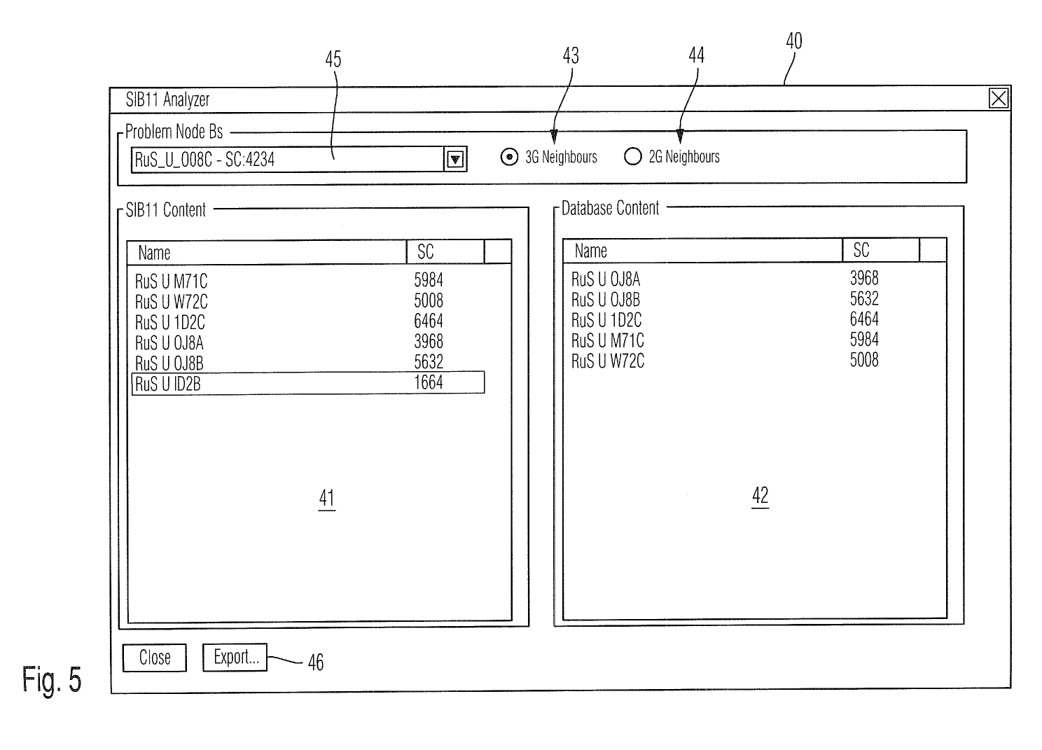

By way of example, FIG. 5 illustrates an analysis of a real, existing mobile-telephone network. FIG. 4 shows a window 30 containing a table 31, in which the results for a plurality of transmitter pairs (TopM; BS) are presented. In each case, one transmitter pair (TopM; BS) is indicated with the reference numbers 32.1 to 32.7 in FIG. 4. Arranged below every transmitter pair 32.1 to 32.7 of this kind, several results, which relate to a given transmitter pair (TopM; BS), are presented in their own line. For the transmitter pair (TopM; BS) with the reference number 32.4, this is shown in lines 34.1 to 34.3. The general information relating to the transmitter pair (TopM; BS) in line 32.4 is combined in the line marked 32.4. The identification of the two transmitters forming the pair is initially presented there. The receivable transmitter TopM is identified by the information provided at reference number 35.1. The target transmitter, indicated in FIG. 4 by 35.2, is placed in square brackets after this. Furthermore, a time, a distance and an item of information relating to the test results obtained are indicated in the first line of the part of the table associated with the transmitter pair (TopM; BS). It is evident from lines 34.1 to 34.3, that the receivable transmitter 35.1 has been identified in each case as a potential interferer PI of type 2. For this purpose, PI2 is indicated as an abbreviation for the type2 potential interferer in the column 39 headed “Type”.

In order to generate results in a targeted manner even for special test situations, a filter can be used during the evaluation of the test results. An appropriate switch 36 is provided for this purpose. Various filters, which can be selected via the tick boxes 37.1 to 37.4, can be used via the switch 36. In the exemplary embodiment presented, the tick box 37.1 relates to a potential decoding of a so-called system information block (SIB) of the transmitted signal. In the present case, this is SIB11. In the system information block 11, a transmitter indicates which neighbor transmitters can be considered as active transmitters. This list of transmitters transferred in the SIB11 is referred to below as the transferred neighbor list. According to a second aspect of the present invention, this transferred neighbor list is tested with regard to identity with the transmitter list TopN_{Prov.} read in by the measuring device. As soon as a deviation between the transferred neighbor list and the read-in transmitter list TopN_{Prov.} is determined, an alarm is triggered. This alarm may be, for example, a direct communication with the respectively-responsible provider.

Another tick box 37.2 can indicate whether the output of information regarding the different transmitter pairs 32.1 to 32.7 will indicate which type of potential interferer PI is present. Furthermore, it is possible to select whether, only close neighbor transmitters, which belong to the third-generation mobile-telephone network or those which belong to the second-generation mobile-telephone network should be listed in the display of the potentially-active transmitter MN. All of the tick boxes 37.1 to 37.4 can be selected in any combination with one another. The subsequent application of the selection is implemented via the switch 36.

Moreover, using the parameter fields 38.1 to 38.3, it is possible to select whether a new measurement should always be started, for example, when a test vehicle has covered a specified distance of the test run. In the exemplary embodiment presented, 10 meters has been selected as the distance value, during which a triggering should not be implemented. The corresponding tick box in the illustrated case is not ticked either for distance (38.1) or for time (38.2). The pre-set time for the triggering of an analysis of the determined transmitter pairs is 10 seconds. It is also possible to implement a given number of measurements for one location.

FIG. 5 shows a further example of a window capable of being presented on a computer screen. This window provides a first region 41 and a second region 42, the neighbor list transferred from a target transmitter 35 being shown in the first region 41. This is compared in the second region 42 with the transmitter list TopN_{Prov.} supplied by the provider with reference to the target transmitter. Here also, it is possible to select via selection windows 43 and 44, whether only third-generation neighbor transmitters should be shown or whether second-generation neighbor transmitters should be shown. In this context, any receivable transmitter can be selected from a pull-down menu 45 as the target transmitter BS independently of the determined quality criteria qc. According to the preferred exemplary embodiment illustrated, the non-agreement is shown highlighted. Via an “export” switch 46, it is also possible either to store the result, that is to say, the difference between the transferred neighbor list and the transmitter list TopN_{Prov.} from the provider, in a storage device, or to transfer it directly, for example, via a radio interface to the provider.

Given sequences from the signals emitted by the individual transmitters are evaluated in order to identify the transmitters presented. In this context, it is particularly advantageous to evaluate the identification code CI (cell identity) of every transmitter from a given system information block (SIB3). If it is not possible to decode a corresponding portion of the transmitted signal received from the transmitter TopM, the received signal can be allocated to a given transmitter via geographical positioning as an alternative. The exact positions of the transmitters are indicated by the network operator, for example, on an electronic map, which is read in by the measuring device. This electronic map can also provide the basis for a display of the analysis results.

Moreover, it is advantageous to determine the respective location of the measuring device or of the test vehicle automatically, for example, with the assistance of a GPS signal.

In order to achieve an unambiguous allocation between the received transmitters and those, which are indicated by the provider in the TopN_{Prov.} list, a valid transmitter list TopN_{Prov.}, which allows an unambiguous identification of the transmitter TopM, must be supplied by the provider. For this purpose, the transmitter list TopN_{Prov.} contains information regarding the country of the mobile-telephone network under consideration (mobile network country, MNC), a regional code (local area code; LAC), information from neighbors of the network cells with third-generation mobile-telephony transmitters (3G neighbors cells; 3GNC) and information from transmitters of the neighbor cells, which are associated with second-generation mobile-telephony cells (2G neighbors cells; 2GNC). The above description relates to the analysis of a network in a region, where a potential mobile-telephone device operates in the UMTS mode. If a region is investigated, in which a UMTS mode is not potential, the measuring device evaluates only the quality criterion qc for determining the target transmitter. In the case of a 2G network, the signal strength received is used as the quality criterion qc (RxLev).

The invention is not restricted to the preferred exemplary embodiment presented here. On the contrary, individual features described in detail above can be combined with one another as required without deviating from the method according to the invention.

1. A method for analyzing cellular mobile-telephone networks, said method comprising:
determining at least one quality criterion for several transmitters receivable at one location;
specifying the transmitter with the best quality as a target transmitter;
forming transmitter pairs from the target transmitter and in each case one receivable transmitter;
testing for at least one part of the transmitter pairs formed in this manner, whether the receivable transmitter of a transmitter pair is a possible active neighbor or a potential interferer,
wherein the receivable transmitters provide a ranking, which represents the quality of the receivable transmitter, the testing of the transmitter pairs corresponds to the rank order, and
wherein, in the case of a marking of the receivable transmitter as a potential interferer, a distinction is made between a first type and a second type, and a marking as a potential interferer of the first type is implemented if the receivable transmitter is not contained in the read in transmitter list made available by the provider and is identified as a potential interferer, and a marking as a potential interferer of the second type is implemented, if the receivable transmitter is contained in the transmitter list and is identified as a potential interferer.

2. The method according to claim 1,
wherein a specified transmitter list for the target transmitter is read in, and this transmitter list is checked for the presence of the receivable transmitter of a transmitter pair.

3. The method according to claim 2,
wherein, in the absence of the receivable transmitter of a transmitter pair from the transmitter list, the at least one quality criterion is compared with a first comparison criterion, and, in the case of a fulfilment of the first comparison criterion, the receivable transmitter is marked as a possible active neighbor, if a maximum number of active neighbors for the target transmitter has not yet been reached.

4. The method according to claim 3,
wherein, in the absence of the receivable transmitter of a transmitter pair from the transmitter list, the at least one quality criterion is compared with the first comparison criterion and with a second comparison criterion, and, in the case of a fulfilment of the first and the second comparison criteria, the receivable transmitter is marked as a potential interferer, if the maximum number of active neighbors has already been reached.

5. The method according to claim 2,
wherein the receivable transmitter of a transmitter pair is marked as a potential interferer, if it is listed in the transmitter list, and the maximum number of active neighbors has already been reached.

6. The method according to claim 2,
wherein the results of the comparisons are stored in a table.

7. The method according to claim 1,
wherein the at least one quality criterion of the receivable transmitter is compared with an absolute threshold value and/or with a relative threshold value and, if the absolute and/or the relative threshold value are exceeded by the quality criterion, a transmitter pair is formed from this receivable transmitter and the target transmitter.

8. The method according to claim 1,
wherein a test is implemented to determine whether the respective received transmitter of a transmitter pair is a possible active neighbor or a potential interferer for all of the transmitter pairs formed.

9. The method according to claim 1,
wherein the test is repeated for a plurality of locations, and the results for the plurality of locations are stored in tabular form for the transmitter pairs.

10. The method according to claim 1,
wherein an identification of the receivable transmitters is implemented by decoding a signal received from this transmitter and by evaluating a transmitter identification code contained therein or by taking into consideration its geographical position.

11. The method according to claim 1,
wherein the testing of the transmitter pairs is triggered subject to time control and/or spatial control.

12. The method according to claim 11,
wherein, for a spatially-controlled triggering of the test, an automatic position detection is implemented.

13. The method according to claim 1,
wherein the receivable transmitters are determined by measuring transmission powers on the possible transmission frequencies of the GSM mobile-telephone network and/or the UMTS mobile-telephone network.

14. A method for analysing cellular mobile-telephone networks comprising:
receiving a signal from a transmitter;
decoding of the received signal and determination of a neighbor list transferred therein;
reading in of a transmitter list; and
comparing the transmitter list with the neighbor list and output of an alarm in the case of a determination of any differences,
wherein the type of difference is indicated in the output of the determined differences, and
wherein the difference is immediately transferred to the provider.

15. A digital storage medium with electronically-readable control signals, which is configured to cooperate with a programmable computer or digital signal processor in such a manner that the method according to claim 1 is executed.

16. (canceled)

17. (canceled)

18. A computer software product with program-code means stored on a machine-readable data medium for the implementation of all of the stages according to claim 1, when the software is run on a computer or a digital signal processor.

19. A digital storage medium with electronically-readable control signals, which is configured to cooperate with a programmable computer or digital signal processor in such a manner that the method according to claim 14 is executed.

20. A computer software product with program-code means stored on a machine-readable data medium for the implementation of all of the stages according to claim 14, when the software is run on a computer or a digital signal processor.

21. The method according to claim 3,
wherein the receivable transmitter of a transmitter pair is marked as a potential interferer, if it is listed in the transmitter list, and the maximum number of active neighbors has already been reached.

22. The method according to claim 3,
wherein the results of the comparisons are stored in a table.
